(19) United States
(12) Patent Application Publication
(10) Pub. No.: US 2011/0308691 A1
(43) Pub. Date: Dec. 22, 2011

(54) METHOD AND DEVICE FOR FORMING A PACKET-LIKE BACK-TO-BACK WAFER BATCH

(75) Inventors: Stefan Jonas, Berlin (DE); Lutz Redmann, Kleinmachnow (DE); Robert Hartwig, Dahlwitz-Hoppegarten (DE)

(73) Assignee: Jonas & Redmann Automationstechnik GMBH, Berlin (DE)

(21) Appl. No.: 13/148,592

(22) PCT Filed: Feb. 19, 2010
(86) PCT No.: PCT/DE10/00204

§ 371 Date: Aug. 9, 2011

(30) Foreign Application Priority Data
Feb. 19, 2009 (DE) 102009009548.9

(51) Int. Cl. B32B 37/18

(52) U.S. Cl. 156/60; 156/556

(57) ABSTRACT

Method and device for forming a packet-like back-to-back wafer batch made up of a predetermined even number of wafers that are to be doped on one side. The wafers of one half of the batch are horizontally and congruously arranged on supporting surfaces of a support system which are disposed at a vertical distance from each other. Holding elements of a holding system have a horizontal upper holding surface and a horizontal lower surface and are provided so as to be movable back and forth relative to two adjacent supporting surfaces between a releasing position and a holding position. The wafers of the second half of the batch, which have previously been moved into a position that is offset by 180° relative to the position of the wafers of the first half are inserted into a holding system so each wafer of the second half rests on the horizontal upper holding surface. Each holding element is simultaneously moved outward in the horizontal direction relative to the adjacent supporting surfaces until the horizontal upper holding surface is in the releasing position and the wafer of the second half rests on the wafer of the first half in a suspended manner on the formed air cushion. Each holding element is moved inward in the horizontal direction into the holding position, in which the horizontal lower surface of the holding element fixes the two wafers.

### FIELD AND BACKGROUND OF THE INVENTION

The invention relates to a method for forming a packet-like back-to-back wafer batch (BTB wafer batch) made up of a predetermined even number of wafers, such as solar wafers, which are to be doped on one side, wherein the wafer batch is divided into two halves, the wafers of one half of the wafer batch are offset into a position in which the wafers are rotated by 180° relative to the wafers in the other wafer batch, and wherein the two halves of the wafer batch are then joined into each other and the side which is not to be doped of each wafer from one half of the wafer batch is placed congruously against the side which is not to be doped of the corresponding adjacent wafer from the other half of the wafer batch.

The invention furthermore relates to a device for carrying out the method according to the invention.

EP 1 925 577 A1 discloses such a method, in which the first half of the number of the wafers arranged in rows in the transfer carrier in the form of the first wafer stack is removed from the transfer carrier by a multiple vacuum gripper, transferred in a servo-controlled manner to an insertion position of the process boot and introduced into the receiving slot thereof in the insertion position, whereupon the second half of the number of the wafers arranged in rows in the transfer carrier is removed from the transport carrier by the multiple vacuum gripper in the form of the second wafer stack, pivoted by 180° relative to the position of the first wafer stack in the process boot and positioned above in alignment with the wafers in the insertion position in the process boot offset by a distance from this insertion position, which distance is at least as great as the wafer thickness, whereupon the multiple vacuum gripper introduces the second wafer stack which is pivoted by 180° into the first wafer stack in the insertion position of the process boot, wherein the wafers which are associated with each other of the first and second wafer stacks are placed with the wafer sides which are not to be doped congruously against each other, forming the packet-like BTB wafer batch.

In the known prior art, the forces acting on the wafer due to the force-fitting gripping have proven problematic. These force effects can cause damage to the wafers, e.g. in the form of microcracks. Such damage can result in a reduction in the efficiency of the end product, e.g. of the solar cell, and must be avoided.

### SUMMARY OF THE INVENTION

The invention is based on the object of finding a solution to place e.g. wafers with their respective side which is not to be doped congruously against each other and in the process exert as little force as possible on the wafers, so that the wafers form a packet-like back-to-back wafer batch in a contact-protective manner.

This object is achieved according to the invention by all the features of the method according to Patent Claim 1 and by all the features of the device according to Patent Claim 4. Patent Claims 2 and 3 and Patent Claims 5 to 10 provide preferred configurations of the method according to the invention or of the device according to the invention.

With the method according to the invention, a back-to-back wafer batch is composed in such a manner that a pair of wafers is always placed with their sides which are not to be doped congruously against each other in one processing unit. Particularly advantageous here is the possibility of doubling the packet thickness for further processing of the wafers. The device according to the invention for carrying out the method correspondingly ensures the above-mentioned advantages.

The wafers of one half of the even number of wafers of the wafer batch provided are each arranged horizontally and congruously in a support system with their sides which are to be doped aligned. The comb-like support system consists of an even number of support elements arranged one above the other and permanently connected to each other by means of a common base element. The support elements each have upper and lower support surfaces. The number of support elements depends on the number of wafers. The support surfaces must each be positioned at a vertical distance a from each other.

Furthermore, a holding system consisting of a plurality of holding elements is provided, wherein the holding elements each have a horizontal upper holding surface and a horizontal lower holding surface. The holding elements which are connected to each other by a fixed distance are each situated between a lower and an upper support surface of the support element and are arranged in the horizontal direction in such a manner that they can be moved by the holding system into a release position or a holding position relative to in each case two adjacent support elements.

The wafers of one half of the wafer batch face in the direction of the horizontal lower surface of a holding element with the side which is not to be doped.

The number of the wafers of the other half of the wafer batch, the wafers of which have previously been moved into a position offset by 180° relative to the position of the wafers in one half of the wafer batch, is inserted into the arrangement of the number of wafers of one half of the wafer batch situated on the support surfaces. This takes place in such a manner that each wafer of the other half of the wafer batch comes to lie with its side which is not to be doped on the horizontal upper holding surface of the corresponding holding element situated in the holding position.

Each holding element is then simultaneously moved by the holding system outwards in the horizontal direction relative to the adjacent support surfaces until its horizontal upper holding surface reaches the release position.

The associated wafer of the other half of the wafer batch situated on the upper holding surface thereby falls under gravity with its side which is not to be doped onto the side which is not to be doped of the associated wafer of the one half of the wafer batch which is situated on the horizontal lower support surface of the two corresponding adjacent support surfaces and is at the same time damped during its fall by the air cushion between the wafers which are to be brought congruously into contact with each other from one and the other half of the wafer batch.

Each holding element is then moved inwards in the horizontal direction into its holding position so that the two wafers are fixed by means of the lower horizontal surface of the holding element and then lie with their sides which are not to be doped against each other on the associated lower support surface.

The support system of the device according to the invention is preferably designed in such a manner that the vertical distance a between two adjacent support surfaces is produced at least from three times the thickness d of a wafer plus the wall thickness e of a support element plus tolerance plus the vertical height h of one holding element. Furthermore, the horizontal upper holding surface of each holding element in its holding position can be positioned at a distance b from the adjacent upper support surface, which is selected to be at least equal to the thickness d of a wafer plus tolerance. The vertical distance a between support surfaces which are adjacent to each other is in each case equal. Furthermore, the distance c of the horizontal lower surface of each holding element from the adjacent lower support surface in the holding position of the holding element is preferably equal to twice the thickness d of a wafer plus tolerance.

The air cushion between the wafers to be brought congruously into contact with each other produces a gentle lowering of the wafer of the other half of the wafer charge released by the horizontal upper holding surface onto the associated wafer from the one half of the wafer batch, which wafer is situated on the corresponding horizontal lower support surface, as a result of which the wafers are subject to a lower breakage rate.

Instead of BTB-wafer batches, BTB batches of any flat substrate can also be formed with the method according to the invention. It is also possible to position the wafers of one half of the wafer batch on the respective horizontal upper holding surfaces of the holding elements of the holding system instead of on the respective support surfaces of a support system, and to position the wafers of the other wafer batch which are pivoted by 180° on the corresponding support surfaces of the support system instead of on the horizontal upper holding surfaces of the corresponding holding elements.

### BRIEF DESCRIPTION OF THE DRAWINGS

The invention is now explained using the drawings. In the drawings:

FIG. 1 shows a front view of an individual support element pair of the device according to the invention, with holding elements in the holding position and with wafers on the lower support surface or on the holding surface,

FIG. 2 shows a front view of an individual support element pair of the device according to the invention corresponding to FIG. 1, with holding elements in the release position and an air cushion indicated,

FIG. 3 shows a front view of an individual support element pair of the device according to the invention, with holding elements in the release position and the falling movement of the wafer indicated,

FIG. 4 shows an illustration of the final position of the wafers lying congruously on top of one another inside an individual support element pair,

FIG. 5 shows an illustration of the fixing of the wafers lying congruously on top of one another by means of the horizontal lower surface of the holding elements,

FIG. 6 shows a front view of the device according to the invention for carrying out the method, with the entire support system and holding system, and

FIG. 7 shows a schematic detailed view of one embodiment for carrying out the method.

### DETAILED DESCRIPTION

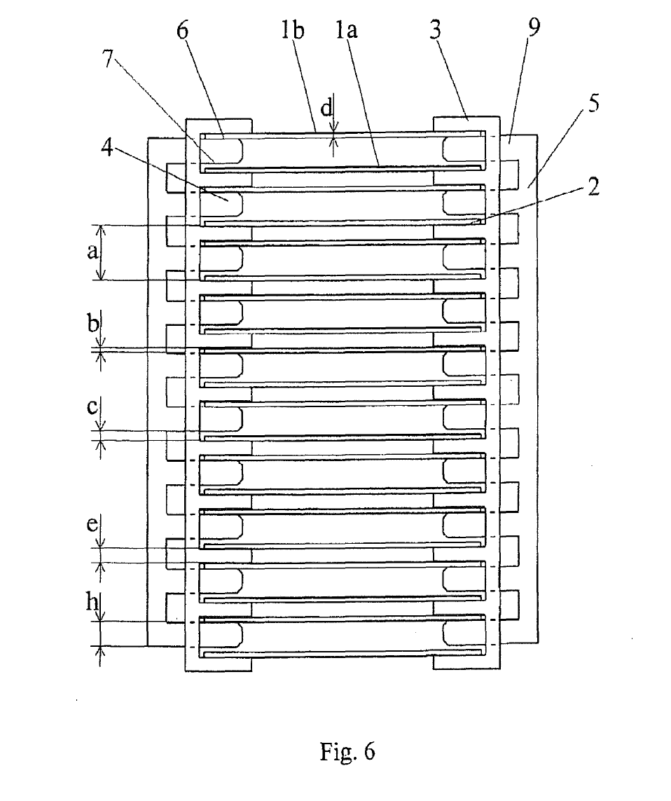

As can be seen in FIG. 6, the wafers 1a of the first half of the provided wafer batch are each placed horizontally and congruously with their side which is to be doped on a corresponding number of support surfaces 2 of support elements 11 of a support system 3, which support elements are arranged one above the other and in mirror-image pairs, wherein the support surfaces 2 are connected to each other in each case by means of a common base element 12. In the embodiment of FIG. 6, the support surfaces 2 are each arranged at an identical vertical distance a from each other.

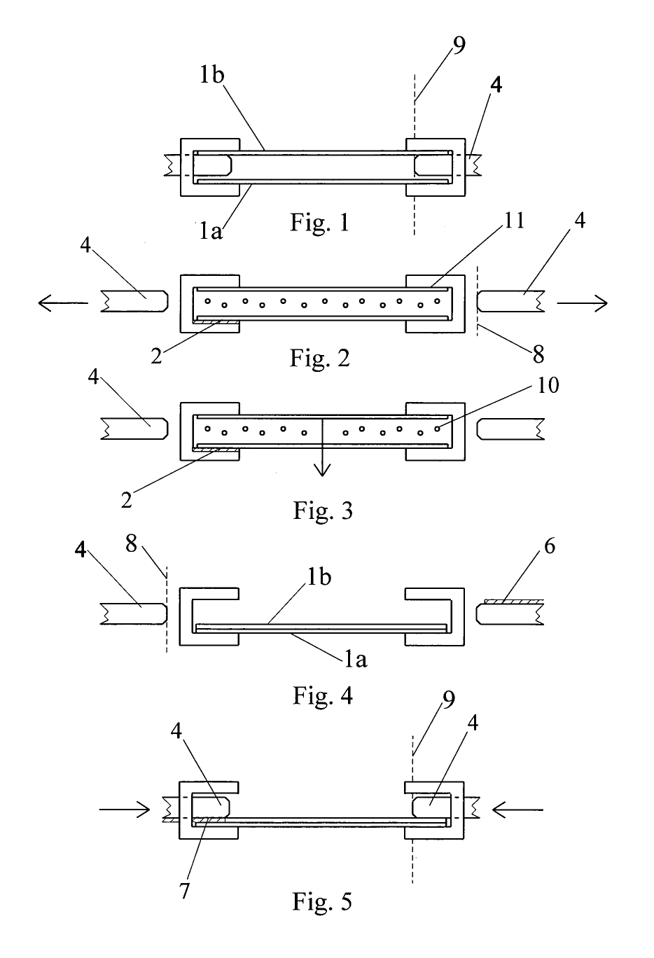

Furthermore, holding elements 4 of a holding system 5 are provided, which are each provided with a horizontal upper holding surface 6 and a horizontal lower surface 7. These are situated between two adjacent support surfaces 2, in the horizontal direction relative thereto (FIG. 2). According to the invention, the holding elements 4 are moved to and fro by means of the holding system 5 between a release position 8 and a holding position 9.

The wafers 1b of the second half of the wafer batch, which have been previously moved into a position rotated by 180° relative to the position of the wafers 1a of the first half of the wafer batch, are, as shown in FIG. 6, inserted into the device in such a manner that each wafer 1b comes to lie with the side which is not to be doped on the horizontal upper holding surface 6 of the corresponding holding element 4 which is in the holding position 9.

Each holding element 4 is then, as shown in FIGS. 2 and 3, to be moved simultaneously outwards in the horizontal direction relative to the adjacent support surfaces 2 until the holding element 4 has reached the release position 8.

As shown in FIG. 3, the associated wafer 1b of the second half of the wafer batch thereby falls under gravity onto the side which is not to be doped of the associated wafer 1a of the first half of the wafer batch, which is situated on the lower support surface 2 of the two corresponding adjacent support surfaces 2. During its fall, the wafer 1b, as shown in FIG. 3, is damped by the air cushion 10 between the wafers 1a and 1b to be brought congruously into contact with each other. FIG. 4 shows the wafers 1a and 1b with their sides which are not to be doped lying on top of each other in their final position.

Then, according to FIG. 5, each holding element 4 is moved inwards in the horizontal direction by the holding system 5 into the holding position 9 in which the horizontal lower surface 7 of the holding element 4 fixes the two wafers 1a and 1b.

FIG. 6 shows that the vertical distance a between two adjacent support surfaces 2 is at least equal to three times the thickness d of a wafer 1a or 1b plus the width e of a support element 11 with the horizontal support surface 2 plus tolerance plus the vertical height h of a holding element 4.

According to the invention, the horizontal upper holding surface 6 of each holding element 4 in its holding position 9 is positioned at a distance b from the adjacent upper support surface 2, which is at least equal to the thickness d of a wafer 1a or 1b plus tolerance. FIG. 6 also shows that the distance c of the horizontal lower surface 7 of each holding element 4 from the adjacent lower support surface 2 in the holding position 9 of the holding element 4 is defined by twice the thickness d of the wafer 1a or 1b plus tolerance.

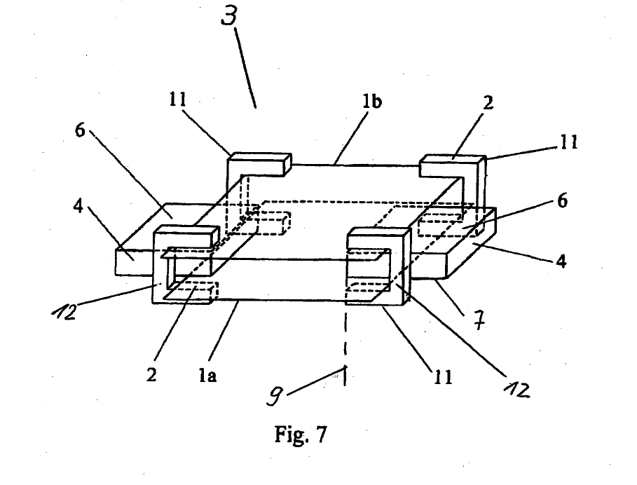

FIG. 7 schematically shows an individual device part according to the invention of the support system 3 of the entire device for carrying out the method, which has at least two identical U-shaped support elements 11 which are arranged in a mirror-image manner to each other, in two planes A and B which are arranged in parallel at a distance from each other. Each base element 12 thereof is arranged at a distance corresponding to the width of a wafer 1a; 1b. The support elements 11 each have a lower support surface 2 lying in a horizontal plane C and an adjacent upper support surface 2 lying in a horizontal plane E. According to the invention, the wafer 1a of the first half of a wafer batch is to be placed with its side which is to be doped onto the lower support surface 2.

Furthermore, the holding system 5 contains two identical holding elements 4, which are each arranged in the intermediate space between the U-shaped support elements 11 located in planes A and B. These holding elements 4 have a holding position 9 and a release position 8, into which they move by horizontal movement relative to the support surfaces 2 of the U-shaped support elements 11, wherein the holding elements 4 have reached their release position 8 when they are outside the support system 3. The holding position 9 is present when the holding elements 4 have moved inwards in the horizontal direction at least beyond the base element 12 of the support system 3 which limits receipt of the wafer. The holding elements 4 are each equipped with the horizontal upper holding surface 6 and the horizontal lower surface 7, wherein the latter is arranged at a distance c from the lower support surface 2 of the U-shaped support elements 11 which corresponds to twice the thickness d of a wafer 1a or 1b plus tolerance, wherein the at least one wafer 1b of the second half of the wafer batch which has been previously moved into a position offset by 180° relative to at least one wafer 1a of the first half of the wafer batch is situated on the horizontal upper holding surfaces 6 of the two holding elements 4 in their holding position 9. When the holding elements 4 move in the direction of the release position 8, the wafer 1b is released from the holding position 9 and slides under the action of gravity onto the wafer 1a, which is positioned on the lower support surfaces 2 of the U-shaped support elements 11, in such a manner that the sides which are not to be doped of the wafers 1a and 1b lie congruously on top of each other. After the holding elements 4 have moved back inwards in the direction of the holding position 9, the wafers 1a; 1b are fixed by the horizontal lower surface 7 of the holding element 4.

### REFERENCE LIST

1a; 1b Wafer
2 Support surface
3 Support system
4 Holding element
5 Holding system
6 Horizontal upper holding surface
7 Horizontal lower surface
8 Release position
9 Holding position
10 Air cushion
11 Support element
12 Base element
a Vertical distance between adjacent horizontal supports
b Distance between the horizontal upper holding surface and the upper support surface
c Distance between the horizontal lower surface and the lower support surface
d Thickness of a wafer
e Wall thickness of the support element
h Height of the holding element

1. Method for forming a packet-like back-to-back wafer batch (BTB wafer batch), made up of a predetermined even number of wafers that are to be doped on one side, such as solar wafers, wherein the wafer batch is divided into two halves, the wafers of one half of the wafer batch are rotated by 180 degrees and the two halves of the wafer batches are then joined into each other, wherein the side which is not to be doped of each wafer is applied congruously to the side which is not to be doped of the corresponding adjacent wafer, characterised by the following method steps to be carried out consecutively:
the wafers (1a) of one half of the even number of wafers of the provided wafer batch are horizontally and congruously arranged with their sides which are to be doped on a corresponding number of supporting surfaces (2) of support elements (11), which lie one above the other, of a support system (3) which are each positioned at a vertical distance a from each other;
the wafers (1b) of the other half of the even number of wafers of the provided wafer batch, which wafers are rotated by 180 degrees relative to the position of the wafers (1a), are inserted into the arrangement of the even number of wafers (1a) situated on the support surfaces (2) in such a manner that each wafer (1b) of the other half of the wafer batch comes to lie with the side which is not to be doped on a horizontal upper holding surface (6) of a holding element (4),
each holding element (4) is simultaneously moved by a holding system (5) outwards in the horizontal direction relative to the adjacent support surfaces (2) until its horizontal upper holding surface (6) reaches a release position (8),
the associated wafer (1b) of the other half of the wafer batch is lowered under gravity onto the side which is not to be doped of the wafer (1a) of one half of the wafer batch, which wafer is situated on the support surfaces (2),
each holding element (4) is moved inwards in the horizontal direction by the holding system (5) for fixing the two wafers (1a) and (1b) into a holding position (9), in which a horizontal lower surface (7) of the holding element (4) then fixes the two wafers (1a) and (1b), which lie with their sides which are not to be doped against each other on the lower support surface (2).

2. Method according to claim 1, characterised in that the release position (8) is achieved when the end of the holding elements (4) which is in the direction of the device is outside a base element (12) of the support elements (11).

3. Method according to claim 1, characterised in that the holding position (9) is achieved when the end of the holding elements (4) which is in the direction of the device is inwards in the horizontal direction at least over the support surface (2).

4. Device for carrying out the method according to claim 1, characterised by
a support system (3), which has two identical U-shaped support elements (11) arranged in a mirror-image manner to each other in two vertical planes (A and B) arranged in parallel at a distance from each other, the base elements (12) of which support elements are arranged at a distance corresponding to the width of a wafer (1a; 1b) plus tolerance and which each have a lower horizontal support surface (2) which lies in a horizontal plane C and an adjacent upper horizontal support surface (2) which lies in a horizontal plane E and is situated at a distance a, on which the at least one wafer (1a) of one half of a wafer batch is arranged with its side to be doped,
and a holding system (5) having at least two identical holding elements (4), which are each equipped with horizontal upper holding surfaces (6) and horizontal lower surfaces (7) and which are each movably arranged in the intermediate space between the U-shaped support elements (11) parallel to the support surfaces (2) thereof, wherein the horizontal lower surface (7) is arranged at a distance c from the lower support surface (2) and the wafers (1b) lie on the upper horizontal holding surfaces (6) of the two holding elements (4) in the holding position (9) thereof, so that when the holding elements (4) move into their release position (8), the wafer (1b) slides onto the wafer (1a) which is positioned on the lower support surfaces (2) of the U-shaped support elements (11), and thereby the sides which are not to be doped of the wafers (1a; 1b) lie congruously on top of one another and the wafers (1a and 1b) are fixed by the holding elements (4) after the latter move back into the holding position (9).

5. Device according to claim 4, characterised in that the support system (3) is arranged multiply on top of one another.

6. Device according to claim 4, characterised in that the distance c of the horizontal lower surface (7) of each holding element (4) from the adjacent lower support surface (2) in the holding position (9) of the holding element (4) is equal to twice the thickness d of the wafer (1a; 1b) plus tolerance.

7. Device according to claim 4, characterised in that each vertical distance a between adjacent support surfaces (2) is equal.

8. Device according to claim 4, characterised in that the vertical distance a between two adjacent support surfaces is at least equal to three times the thickness d of a wafer plus the wall thickness e of a support element (11) plus tolerance plus the vertical height h of one holding element (4).

9. Device according to claim 1, characterised in that the horizontal upper holding surface (6) of each holding element (4) in its holding position (9) is positioned at a distance b from the adjacent upper support surface (2), which is at least equal to the thickness d of a wafer (1a; 1b) plus tolerance.

10. Device according to claim 1, characterised in that the holding elements (4) are arranged such that they can move in the horizontal direction between a holding position (9) in the support system (3) and a release position (8) outside the support system (3).

11. Device according to claim 5, characterised in that the distance c of the horizontal lower surface (7) of each holding element (4) from the adjacent lower support surface (2) in the holding position (9) of the holding element (4) is equal to twice the thickness d of the wafer (1a; 1b) plus tolerance.

12. Device according to claim 5, characterised in that each vertical distance a between adjacent support surfaces (2) is equal.

13. Device according to claim 6, characterised in that each vertical distance a between adjacent support surfaces (2) is equal.

14. Device according to claim 5, characterised in that the vertical distance a between two adjacent support surfaces is at least equal to three times the thickness d of a wafer plus the wall thickness e of a support element (11) plus tolerance plus the vertical height h of one holding element (4).

15. Device according to claim 6, characterised in that the vertical distance a between two adjacent support surfaces is at least equal to three times the thickness d of a wafer plus the wall thickness e of a support element (11) plus tolerance plus the vertical height h of one holding element (4).
